(19) United States
(12) Patent Application Publication
(10) Pub. No.: US 2014/0281608 A1
(43) Pub. Date: Sep. 18, 2014

(54) Battery Usage Throttling for Mobile Devices

(71) Applicant: Google Inc., Mountain View, CA (US)

(72) Inventors: Li Yin, Redmond, WA (US); Hong Zhang, Redmond, WA (US)

(73) Assignee: Google Inc., Mountain View, CA (US)

(21) Appl. No.: 14/071,714

(22) Filed: Nov. 5, 2013

Related U.S. Application Data
(60) Provisional application No. 61/782,491, filed on Mar. 14, 2013.

(51) Int. Cl. G06F 1/32

(52) U.S. Cl. CPC G06F 1/3212; G06F 1/3234
USPC 713/320

(57) ABSTRACT

A computing device may be configured to determine a power supply usage rate of the computing device based on operations of applications and power-consuming components of the computing device. The computing device may be configured to obtain a target power supply depletion rate. Based on the power supply usage rate exceeding the target power supply depletion rate, the computing device may be configured to adjust an operation of an application of the applications and/or an operation of a power-consuming component of the power-consuming components so as to cause the power supply usage rate to substantially meet the target power supply depletion rate.

### CROSS REFERENCE TO RELATED APPLICATION

The present application claims priority to U.S. Provisional patent application Ser. No. 61/782,491, filed on Mar. 14, 2013, and entitled “Automatic Standby Battery Usage Throttling for Mobile Devices,” which is herein incorporated by reference as if fully set forth in this description.

### TECHNICAL FIELD

Aspects of the present application relate to power use in electronic devices. More specifically, certain implementations of the present disclosure relate to standby battery usage throttling for mobile devices.

### BACKGROUND

Various types of electronic devices are commonly used nowadays. In this regard, some electronic devices may be hand-held and mobile, may support communication (wired and/or wireless), and/or may be general-purpose or special-purpose devices. Examples of electronic devices may include personal computers, laptops, cellular phones, smartphones, tablets, and the like. Because in some instances electronic devices may be configured to support mobility (e.g., enabling use on the move), such electronic devices may comprise internal power sources (e.g., batteries), which provide power when connection to external power sources (e.g., electrical outlets) may not be feasible. The internal power supply components of electronic devices may only provide power, however, for a limited period of time, and may be depleted rapidly, especially during extensive and continued use on the move. Further limitations and disadvantages of conventional and traditional approaches will become apparent to one of skill in the art, through comparison of such approaches with some aspects of the present method and apparatus set forth in the remainder of this disclosure with reference to the drawings.

### SUMMARY

Within examples, devices and methods for standby battery usage throttling for mobile devices are provided.

In one aspect, the present disclosure describes a method. The method comprises obtaining a target power supply depletion rate for a power supply of a device having a plurality of applications and a plurality of power-consuming components. The method also comprises initiating performance of one or more operations requested by one or more applications of the plurality of applications using one or more power-consuming components of the plurality of power-consuming components. The method further comprises determining that a power supply usage rate of the device exceeds the target power supply depletion rate; and determining one or more adjustments to one or both of: the one or more operations, and usage of the one or more power-consuming components. The method also comprises applying the one or more adjustments so as to cause the power supply usage rate to substantially meet the target power supply depletion rate.

In still another aspect, the present disclosure describes a device. The device comprises a plurality of applications; a power supply; a plurality of power-consuming components; at least one processor in communication with the plurality of applications, the power supply, and the plurality of power-consuming components; and data storage comprising executable instructions that, when executed by the at least one processor, cause the device to perform functions. The functions comprise obtaining a target power supply depletion rate for the power supply. The functions also comprise initiating performance of one or more operations requested by one or more applications of the plurality of applications using one or more power-consuming components of the plurality of power-consuming components. The functions further comprise determining that a power supply usage rate of the device exceeds the target power supply depletion rate; and determining one or more adjustments to one or both of: the one or more operations, and usage of the one or more power-consuming components. The functions also comprise applying the one or more adjustments so as to cause the power supply usage rate to substantially meet the target power supply depletion rate.

In another aspect, the present disclosure describes a computer readable medium having stored thereon instructions that, when executed by a computing device, cause the computing device to perform functions. The functions include determining a power supply usage rate of the computing device based on one or more operations of a plurality of applications and a plurality of power-consuming components of the computing device. The functions also comprise obtaining a target power supply depletion rate. The functions further comprise based on the power supply usage rate exceeding the target power supply depletion rate, adjusting one or both of: an operation of an application of the plurality of applications, and an operation of a power-consuming component of the power-consuming components so as to cause the power supply usage rate to substantially meet the target power supply depletion rate.

In still another aspect, the present disclosure describes a device. The device comprises a means for determining a power supply usage rate of the device based on one or more operations of a plurality of applications and a plurality of power-consuming components of the device. The device also comprises means for obtaining a target power supply depletion rate. The device further comprises means for, based on the power supply usage rate exceeding the target power supply depletion rate, adjusting one or both of: an operation of an application of the plurality of applications, and an operation of a power-consuming component of the power-consuming components so as to cause the power supply usage rate to substantially meet the target power supply depletion rate.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a block diagram illustrating an example power usage throttling technique in electronic devices, in accordance with an example embodiment.

FIG. 2 illustrates is a block diagram illustrating an electronic device that may support power usage throttling, in accordance with an example embodiment.

FIG. 3 is a flow chart that illustrates an example process for power usage throttling in electronic devices, in accordance with an example embodiment.

FIG. 4 is a flow chart that illustrates an example process for configuring power usage throttling-related priorities in an electronic device, in accordance with an example embodiment.

### DETAILED DESCRIPTION

The present disclosure relates to a method and system for standby battery usage throttling for mobile devices. As utilized herein the terms “circuits” and “circuitry” refer to physical electronic components (i.e., hardware) and any software and/or firmware (“code”), which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “e.g.,” introduces a list of one or more non-limiting examples, instances, or illustrations.

FIG. 1 is a block diagram illustrating an example power usage throttling technique in electronic devices, in accordance with an example embodiment. Referring to FIG. 1 there is shown an electronic device 100. The electronic device 100 may comprise suitable circuitry, interfaces, logic, and/or code for performing, executing or running various operations, functions, applications and/or services. In some instances, the electronic device 100 may comprise components or subsystems for enabling interactions with users, such as to obtain user input and/or to provide user output. In some instances, the electronic device 100 may enable and/or support communication of data, such as via wired and/or wireless connections, which may be configured in accordance with one or more supported wireless and/or wired protocols or standards. In some instances, the electronic device 100 may be a handheld mobile device—i.e. intended for use on the move and/or at different locations. In this regard, the electronic device 100 may be designed and/or configured to allow for ease of movement, such as to allow it to be readily moved while being held by the user as the user moves, and the electronic device 100 may be configured to perform at least some of the operations, functions, applications and/or services supported by the device on the move. Examples of electronic devices may comprise handheld devices (e.g., cellular phones, smartphones, and/or tablets), computers (e.g., laptops or desktops), servers, dedicated multimedia devices (e.g., game consoles and portable media players), and/or other similar devices. The disclosure, however, is not limited to any particular type of electronic device. In some instances, electronic devices, such as the electronic device 100 may comprise internal power supply components (e.g., batteries) which may supply power when external power supply (e.g., connection to external power sources, such as electrical outlets) may not be possible. This may be particularly the case when the electronic device 100 comprises a mobile and/or handheld device.

In operation, the electronic device 100 may be utilized (e.g., by the device user) to perform, execute and/or run various functions, applications or services, such as using preconfigured instructions and/or based on real-time user instructions or interactions. In this regard, various types of operations, functions, applications or services may be available in or supported by the electronic device 100. For example, the electronic device 100 may be used for playing video and/or audio content, gaming, email applications (and/or similar type of web based communications), calling services (e.g., voice calls), and/or network services (e.g., WiFi hotspot, Bluetooth piconet, and/or active 3G/4G/femtocell data channels). Some functions, programs and/or applications may be intended for recreational use (e.g., games), while others may be intended for personal use (e.g., shopping, purchases, and banking) or for business/commercial use (e.g., scheduling, and remote access). The functions, applications or services available in the electronic device 100 may require varying amounts of user interactivity—e.g., some may involve constant and/or continuous user interaction, such as games, chats, or call applications; some may require minimal interactions (e.g., playing multimedia content); and some may involve infrequent user interactions, such as email applications.

Performing, executing or running functions, applications or services in the electronic device 100 may involve use of power, such as for activating, driving or running components or subsystems which may be needed—e.g., processing resources, storage resources, communication resources, and/or other dedicated (e.g., video, audio or textual input/output) resources. In some instances, power requirements may differ—i.e. some of the functions, applications or services performed, run or executed by the electronic device 100 may be more power intensive than others. For example, applications or services that involve constant user interactions may require more power than applications that require minimal and/or infrequent user interactions. Also, because communication of data to and/or from the electronic device 100 may consume significant power, applications or services that require communication of data external to the electronic device 100 may consume more power than application or services that are performed exclusively locally at or in the electronic device 100.

The type of communication may also affect power consumption. For example, wireless communications may be more power intensive than wired communications, due to the requirement of higher signal powers as a result of use of a noisier media. In addition, particular interfaces (especially wireless interfaces) that are supported via the electronic device 100, which may be used in facilitating data communication by active applications or services, may continually consume power even during idle times (e.g., for periodic synchronization).

The power consumption associated with execution or running of functions, applications, or services in the electronic device 100 may raise particular challenges in some situations, especially where the electronic device 100 may not be able to connect to steady external power supply, and therefore has to rely on and draw needed power from its internal power storage/supply components (e.g., batteries). In other words, having too many active applications or services running in the electronic device 100 and/or activating, and/or using many resources (hardware and/or software) when the available power source is the device's internal power supply would deplete that internal power supply rapidly.

In various examples, power use and/or consumption in the electronic devices may be controlled, such as to enable reducing the power consumption and/or to preserve power supply. For example, controlling power use and/or consumption may comprise, for example, controlling and/or adjusting operations of the electronic device and/or functions, applications or services available therein, in a manner that may change or adjust (e.g., reduce) power consumption associated therewith. In this regard, operations adjustments may comprise, for example, such actions as shutting down the device, terminating or suspending particular functions, applications or services, or transitioning (device as a whole or individual functions, applications or services) into low power states (e.g., sleep mode). In addition, in some instances, controlling power use and/or consumption may comprise controlling and/or adjusting resource utilization in electronic devices. In this regard, controlling and/or adjusting resources utilization may comprise modifying utilization profile of particular resources, switching between different resources (e.g., those that may be utilized for providing or supporting similar functions), and/or shutting down or deactivating particular resources.

In some examples, controlling power use and/or consumption may be configured in accordance with a particular power consumption rate, which may be preconfigured (e.g., as predefined parameter) and/or specified (e.g., as user-setting). For example, in an example implementation, an adaptive power management technique 110 may be used to optimize power use and/or consumption in electronic devices, such as the electronic device 100, based on internal power supply depletion. In this regard, particularly in instances where the power is based on (i.e. obtained from) internal deplete-able power supply (e.g., battery), the power utilization control may be configured in accordance with a specific depletion rate associated with the internal power supply (e.g., battery depletion rate). The adaptive technique 110 may comprise, for example, monitoring the electronic device 100 and/or operations and ongoing activities in the electronic device 100—e.g., to track current (in real-time or near real-time) power supply and/or power supply depletion rate; determining applicable (target) depletion rate in the device (e.g., based on predetermined parameter or criteria, and/or based on user input); adjusting active functions, applications, and/or services—e.g., based on priority level, current power supply level, and/or target depletion rate (with adjustments applied gracefully or gradually where possible); and adjusting (active) hardware/software (HW/SW) resources—e.g., based on current power supply, target depletion rate, and/or correlation with active functions, applications, and/or services, or any adjustments thereto.

As an example for illustration, a mobile phone may have a plurality of software applications. An application of the plurality of applications may be configured to transmit data wirelessly, for example, using a WiFi antenna and/or via a Bluetooth connection. In some examples, transmitting the data the WiFi antenna consumes more power than the Bluetooth connection. A target power depletion rate may be set to a given rate so as to preserve battery life for the mobile phone. Assuming that in one instance the application is transmitting the data over WiFi and that a power supply usage rate is accordingly larger than the target power depletion rate. The adaptive power management technique may be configured to adjust operation of the application by switching transmission of data using the WiFi antenna to using the Bluetooth connection so as to consume less power.

In examples, the adjustments may be determined and/or applied based on particular profiles. The adaptability of the technique 110 may entail adaptively controlling the selection of functions, applications or services whose operations may be adjusted; the manner by which the operation adjustments may be carried out or applied; and/or resources utilization (e.g., in conjunction with active applications or services) in the electronic device 100 or adjustments thereof. In this regard, ‘adaptive’ control of selection of applications/services/resources and/or of the manner by which adjustments are applied may comprise varying different aspects of the selection and/or the adjustment based on one or more criteria or conditions.

For example, the power management technique 110 applied in the electronic device 100 may be configured to incorporate and/or implement adaptive power based priorities associated with services, applications, and/or resources. In this regard, the power management technique 110 may comprise selecting among active applications, services, or resources that may be selected for operation adjustment (e.g., to meet or substantially meet a particular power depletion rate) based on priority levels associated with the candidate applications or services. For example, in accordance with the power management technique 110, the electronic device 100 may track and/or monitor power supply and/or consumption rate in the device. This tracking and/or monitoring may comprise determining when the electronic device 100 is utilizing internal power supply in a manner that depletes the stored internal power, and if so, determining remaining internal power. The power tracking and/or monitoring may also comprise determining and/or estimating current depletion rates, such as based on remaining internal power supply and/or current power consumption derived therefrom. For example, in instances where the internal power supply comprises a rechargeable battery, the power monitoring and/or tracking may comprise determining when power is being drawn from the battery, and/or (remaining) battery level (e.g., as percentage of remaining charge in the battery, with 100% corresponding to full charge and 0% corresponding to complete depletion of the battery), with the depletion rate being determined (or expressed) as per-time charge percentage usage rate (e.g., 2% per hour).

In accordance with the power management technique 110, the electronic device 100 may determine an applicable (maximum) allowed depletion rate. In this regard, the maximum depletion rate may be specified expressly (e.g., set by the user to a specific value, such as to 3% per hour) or determined indirectly (e.g., calculated based on other related parameter(s), such as based on preset maximum run time under particular conditions—e.g., 15 hour run time when the device is in particular mode, such as ‘standby’ mode). The current depletion rate may then be compared to the maximum allowed depletion rate, to determine if the maximum allowed depletion rate is exceeded or not.

In accordance with the power management technique 110, the electronic device 100 may also track and/or determine priority level associated with each active application or service and/or utilized resource (e.g., software or hardware resource). In this regard, applications, services, and/or resources may be assigned priority levels for use in power related management function(s), such as adaptive operation adjustments based on power depletion rate. For example, a multi-level, such as 3-level, priority technique may be used, whereby each application, service, or resource may be assigned one of three available priority levels (levels ‘1’, ‘2’, and ‘3’), with the different levels correlating to a varying preference for selecting applications/services/resource for operation adjustments. Thus, in the 3-level priority technique, for example, the values of priority levels may represent (e.g., in increasing order) preference for keeping the applications running or particular resource running without any operation adjustment—i.e. priority level ‘3’ may be assigned to applications, services, or resources which may be deemed as most favorite to be kept running without any operation adjustment (e.g., termination) whereas priority level ‘1’ may be assigned to applications, services, or resources which may be least favorite to be kept unchanged. For example, calling services and/or network services may be assigned highest priority (e.g., level ‘3’), email applications may be assigned intermediate priority (e.g., level ‘2’), and all other, remaining applications, such as video applications, audio applications, or gaming applications, being assigned the lowest priority (e.g., level ‘1’). In some instances, default priority level (e.g., lowest priority level) may be assigned to every application, service, or resource available in the electronic device. In other instances, the electronic device 100 may be configured to specify and/or assign priority levels to some applications, services, or resources (or classes or categories of applications, services, or resources) based on some defined criteria (e.g., degree of user interaction with the app/service, whether data is communicated, and/or safety consideration—e.g., whether service or applications pertain to user safety). The electronic device 100 may also allow for specifying priority levels of at least some applications, services, or resources (or classes/categories of applications or services) based on user input or commands.

In accordance with the power management technique 110, the electronic device 100 may adjust operations of one or more active applications, services, or resources based on tracked power supply and priority levels, and/or the manner by which the adjustment is carried out or applied. For example, when an application or service is selected based on the present power supply (level) and/or the priority level, the application or service may be terminated, shutdown, suspended, or put into a sleep mode. Furthermore, the operation adjustment (e.g., termination, shutdown, suspension, or putting into a sleep mode) may be carried out or applied in a graceful or gradual manner, such as in accordance with defined execution criteria that may be configured to minimize unwanted or undesired effects on the electronic device 100 or its user(s). For example, rather than abruptly terminating, shutting down, suspending, or putting into a sleep mode selected application(s) or service(s), the operation adjustments (termination or shutdown) may not be performed until particular execution criteria is met. In this regard, the execution criteria may be configured based on timing and/or performance conditions specifying when the operation adjustment may take place. For example, the execution criteria may comprise a defined delay, determined or estimated such as to allow for completing the most complex function performed by the pertinent application or service, under the worst possible scenario (e.g., if the longest task performed by a video app, under worst scenario is 10 ms, for example, the execution criteria may comprise a 10 ms delay until operation adjustments may be carried out). The execution criteria may also comprise defined exit functions or conditions that ensure that application or service(s) exit(s) cleanly (e.g., releasing any reserved or allocated resources, such as memory or processing, and/or completion on ongoing, incomplete tasks).

Adjustments are applied so as to cause the power supply usage rate to meet or substantially meet the target power supply depletion rate. For example, the power supply usage rate may be considered to substantially meet the target power supply depletion rate when the usage rate is within a threshold rate value from the target depletion rate. For instance, if the usage rate is within about ±2% rate from the target depletion rate, the usage rate is considered to have substantially met the target depletion rate. In another example, the usage rate and the target depletion rate may be expressed as a voltage/hour rate. In this example, if the usage rate is within about±a given voltage/hour value from the target depletion rate, the usage rate is considered to have substantially met the target depletion rate. In still another example, the target depletion rate may be defined as a particular run time (15 hours). In this example, if the usage rate is within about±a given value (e.g., ±0.5 hours) from the target run time, the usage rate is considered to have substantially met the target depletion rate. In some example, the usage rate may not be allowed to exceed the target depletion rate, i.e., allowed to be within a threshold value below the target depletion rate. Thus, instead of the usage rate being within ±a given value from the target rate, the usage rate is allowed to be within the give value below the target rate.

In an example, use of the power management technique 110 may be limited to certain conditions or criteria. For example, the power management technique 110 may be utilized when the electronic device 100 is in particular mode(s)—e.g., ‘standby’ mode, and/or be deactivated when the electronic device 100 is in particular mode(s)—e.g., in ‘active’ mode.

In another example, operation adjustment of active applications or services (e.g., based on power supply) may be disabled. For example, use of the power management technique 110 may be discontinued and/or functions in accordance therewith may be disabled. Feature disabling may be done based on user input or request, for example.

FIG. 2 is a block diagram illustrating an electronic device that may support power usage throttling, in accordance with an example embodiment. FIG. 2 depicts an electronic device 200. The electronic device 200 may comprise suitable circuitry, interfaces, logic, and/or code that may be operable to implement various aspects of the present disclosure. In this regard, the electronic device 200 may correspond to the electronic device 100 of FIG. 1, for example. The electronic device 200 may comprise, for example, a main processor 202, a system memory 204, a communication subsystem 210, an input/output (I/O) subsystem 220, an internal power supply 230, a power management module 240, and a plurality of hardware (HW) and software (SW) resources 250.

The main processor 202 may comprise suitable circuitry, interfaces, logic, and/or code that may be operable to process data, and/or control and/or manage operations of the electronic device 200, and/or tasks and/or applications performed therein. In this regard, the main processor 202 may configure and/or control operations of various components and/or subsystems of the electronic device 200, by utilizing, for example, one or more control signals. The main processor 202 may enable running and/or execution of applications, programs and/or code, which may be stored, for example, in the system memory 204. Alternatively, one or more dedicated application processors may be utilized for running and/or executing applications (or programs) in the electronic device 200.

The system memory 204 may comprise suitable circuitry, interfaces, logic, and/or code that may enable permanent and/or non-permanent storage, buffering, and/or fetching of data, code and/or other information, which may be used, consumed, and/or processed. In this regard, the system memory 204 may comprise different memory technologies, including, for example, read-only memory (ROM), random access memory (RAM), Flash memory, solid-state drive (SSD), and/or field-programmable gate array (FPGA). The system memory 204 may store, for example, configuration data, which may comprise parameters and/or code, comprising software and/or firmware.

The communication subsystem 210 may comprise suitable circuitry, interfaces, logic, and/or code operable to communicate data from and/or to the electronic device 200, such as via one or more wired and/or wireless connections. The communication subsystem 210 may be configured to support one or more wired protocols and/or interfaces, and/or one or more wireless protocols and/or interfaces, facilitating transmission and/or reception of signals to and/or from the electronic device 200 and/or processing of transmitted or received signals in accordance with applicable wired or wireless protocols. Examples of wireless protocols or standards that may be supported and/or used by the communication subsystem 210 comprise wireless personal area network (WPAN) protocols, such as Bluetooth (IEEE 802.15); near field communication (NFC) standards; wireless local area network (WLAN) protocols, such as WiFi (IEEE 802.11); cellular standards, such as 2G/2G+(e.g., GSM/GPRS/EDGE, and IS-95 or cdmaOne) and/or 2G/2G+(e.g., CDMA2000, UMTS, and HSPA); 4G standards, such as WiMAX (IEEE 802.16) and LTE; Ultra-Wideband (UWB), and/or the like. Examples of wired protocols and/or interfaces that may be supported and/or used by the communication subsystem 210 comprise Ethernet (IEEE 802.2), Fiber Distributed Data Interface (FDDI), Integrated Services Digital Network (ISDN), and Universal Serial Bus (USB) based interfaces. Examples of signal processing operations that may be performed by the communication subsystem 210 comprise, for example, filtering, amplification, analog-to-digital conversion and/or digital-to-analog conversion, up-conversion/down-conversion of baseband signals, encoding/decoding, encryption/decryption, and/or modulation/demodulation.

The I/O subsystem 220 may comprise suitable circuitry, interfaces, logic, and/or code for enabling and/or managing user interactions with the electronic device 200, such as obtaining input from, and/or to providing output to, the device user(s). The I/O subsystem 220 may support various types of inputs and/or outputs, including, for example, video, audio, and/or text. In this regard, dedicated I/O devices and/or components, external to (and coupled with) or integrated within the electronic device 200, may be utilized for inputting and/or outputting data during operations of the I/O subsystem 220. Examples of such dedicated I/O devices may comprise displays, audio I/O components (e.g., speakers and/or microphones), mice, keyboards, touch screens (or touchpads), and the like. In some instances, user input obtained via the I/O subsystem 220, may be used to configure and/or modify various functions of particular components or subsystems of the electronic device 200.

The internal power supply 230 may comprise circuitry, interfaces, logic, and/or code for storing and/or supplying power in the electronic device 200. The internal power supply 230 may comprise, for example, a rechargeable battery system which may be configured to draw and store (and convert, voltage and/or type—e.g., AC to DC—if necessary) power from external power sources when the electronic device 200 is connected to these sources (e.g., electrical outlet, using power cable, or another electronic device, such as via USB cable). The stored power may then be outputted, such as via power buses (not shown) to various components of the electronic device 200, to supply power that is required by these components during operations thereof when no external power supply is available.

The power management module 240 may comprise suitable logic, circuitry, interfaces, and/or code for managing power utilization in the electronic device 200. In some instances, the power management module 240 may be configured to implement and/or apply adaptive power management techniques (e.g., technique 110 of FIG. 1), which may comprise controlling and/or adjusting functions, applications and/or services 260, and/or HW/SW resources 250 utilized in conjunction therewith, to enable optimizing power consumption in the electronic device 200.

The plurality of HW/SW resources 250 may comprise different hardware resources and/or software resources in the electronic device 200. For example, software resources may comprise an operating system (OS), applications (Apps), device drivers, browsers, memory management modules, and the like. Hardware resources may comprise physical components that may be used in the electronic device 100—e.g., processors, memory/storage devices, network cards, media input/output devices, etc. Accordingly, while shown in FIG. 2 as separate element, at least some of the plurality of HW/SW resources 250 may correspond to components or devices that are also part of other subsystems in the electronic device 200, such as the main processor 202, the system memory 204, the communication subsystem 210 and/or the I/O subsystem 220.

In operation, the electronic device 200 may implement and/or utilize (e.g., via power management module 240) adaptive power management techniques that may be configured to optimize power use and/or consumption, such as the power management technique 110 of FIG. 1 for example. In this regard, performing, running or executing functions, applications or services 260 supported by the electronic device 200 may involve use or consumption of power, such as to activate, run, and/or drive one or more of the HW/SW resources 250 which may be utilized during that running or execution. The power consumption resulting from execution or running of functions, applications or services 260 in the electronic device 200 (or use of required HW/SW resources 250) may cause some issues, especially where the electronic device 200 may not be connected to steady external power supply. Therefore, the electronic device 200 may rely on and draw power from the internal power subsystem 230, which may result in depletion of the internal power supply (which may be limited) in the electronic device 200. Accordingly, the electronic device 200 may be configured to allow for adjustment of operations of active functions, applications or services 260 in the electronic device 200 and/or HW/SW resources 250 used in conjunction therewith, to extend duration run time based on the internal power supply 230. In this regard, adjusting operations of active functions, applications or services 260 may comprise terminating, shutting down, suspending, or putting into a sleep mode these applications or service. The disclosure, however, is not limited as such, and any operation adjustments that may impact power consumption may be used or applied in the similar manner as described with respect to application or service termination, shutdown, suspended, or putting into a sleep mode.

In this regard, as described in FIG. 1, use of adaptive power management techniques (e.g., technique 110) may enable adaptively managing active functions, applications or services 260, and/or resources (e.g., HW/SW resources 250) that may be used in conjunction therewith, in order to achieve a particular (target) depletion rate—that is the depletion rate of internal power supplies (e.g., the internal power supply 230) does not exceed the specified target depletion rate. The target depletion rate may be configured, such as by specifying a particular value for the target depletion rate (e.g., 2% per hour) or by specifying a particular run time (e.g., 15 hours based only on the internal power supply). The target depletion rate may be inputted by the user (including dynamically) or it may be configured as part of the power management technique. Once the target depletion rate is determined, active functions, applications or services 260, and/or HW/SW resources 250 may be tracked and analyzed, such as to determine the optimal manner to achieve the specified target depletion rate may be achieved. For example, the target depletion rate may be achieved by one or more of: modifying operations of functions, applications or services 260 (e.g., as deemed optimal for achieving the depletion rate versus current battery power level); modifying operations of hardware resources; and/or switching between various available resources (e.g., HW/SW resources 250) that provide analogous functions based on power consumption characteristics associated thereto (e.g., switching from 4G to 3G). To facilitate and/or support particular aspect of the adaptive modifications that may be performed in accordance with such power management techniques, the electronic device 200 may be configured to maintain (e.g., using the power management module 240) resource profile database comprising per-resource power related information (e.g., power requirements, including for different modes or performance criteria). The resource profile database may be checked to determine when resource operations may need to be modified. For example, if resource profile database indicates that use of Bluetooth is expected to result in consuming 5% of the internal power supply 230, then Bluetooth component(s) may be shut down when power consumption associated with use of Bluetooth rises to 10% (thus forcing switch to a different resource). In some instances, rather than shutting down a resource, particular power related performance parameters may be adjusted. For example, when power consumption associated with processing pushes power consumption rate above target depletion rate, CPU speed may be reduced (rather than shutting down the CPU) until the target depletion rate is met. In some instances, the resource profile database may be configurable and/or modifiable (e.g., based on a change in power characteristics for a particular resource).

In some instances, managing functions, application or services 260 (and/or resources—e.g., the HW/SW resources 250) may be based on priority associated therewith. As an example, in instances where no priority is expressly specified, the power management technique may be configured to presume or assign particular priority to particular functions, application or services 260 (and/or resources—e.g., HW/SW resources 250). For example, particular applications or services 260, such as phone or SMS services, may be presumed (unless and until modified by a user) to have higher priority than other services, such as data services, with particular applications or services (e.g., games or other recreational apps) being presumed to have lower priority. Thus, as an example, an adaptive management approach (to achieve particular target depletion rate) may entail shutting down all services except voice calling and SMS services.

In some instances, users may be allowed to prioritize (or adjust presumed default priorities) associated with different functions, application, services 260 or resources (e.g., HW/SW resources 250). For example, some users may choose particular social networking services over Email. Some users may choose to assign Bluetooth higher priority over WiFi. The power management technique may then manage the system based on the modified priorities specified by the users.

In some instances, power consumption-related feedback may be provided to device users (e.g., via the I/O subsystem 220) to indicate when a specified target depletion rate may not be achieved, to provide additional information (such as what services and hardware components have been shut down), and/or to request addition information or preferences by the user(s).

FIG. 3 is a flow chart that illustrates an example process for power usage throttling in electronic devices, in accordance with an example embodiment. Referring to FIG. 3, there is shown a flow chart 300 comprising a plurality of example steps for controlling functions, applications and/or services, and/or resources used in an electronic device (e.g., the electronic device 200 of FIG. 2) based on priority and power usage rate.

The flow chart 300 may include one or more operations, functions, or actions as illustrated by one or more of blocks 302-310. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, the flowchart 300 shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium or memory, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. In addition, for the flow chart 300 and other processes and methods disclosed herein, each block in FIG. 3 may represent circuitry that is wired to perform the specific logical functions in the process.

In step 302, a current applicable internal power supply usage rate may be determined by the electronic device. In this regard, the power supply usage rate may correspond to the (maximum) depletion rate for a battery used in the electronic device to provide power when external power supply is unavailable. The current applicable internal power supply usage rate may be determined based on, for example, user input (e.g., as provided by the user using an I/O component, such as a touchscreen) and/or based on applicable throttling technique (e.g., a selected one of a plurality of power usage throttling techniques configured in the electronic device).

In step 304, the electronic device may be used to perform one or more requested/scheduled functions, services or applications. In this regard, the performing functions, services or applications may entail power consumption, such as in conjunction with use of software and/or hardware (SW/HW) resources that may be needed for the performance of the functions, services or applications. For example, various applications may require exchange of data from/to the electronic device, which may involve use of processing resources, communication resource (e.g., WiFi cards, network cards, etc.) that would require power.

In step 306, whether the applicable internal power usage rate is exceeded may be determined. In this regard, determining whether the applicable internal power usage rate is exceeded may be based on a determination of current (available) internal power supply (e.g., battery level) in the electronic device and the current power consumption, and calculating the current power depletion rate based on these parameters. Determining whether the applicable internal power usage rate is exceeded (or not) may be performed in various manners—e.g., periodically and/or based on particular conditions (e.g., initiating of new operation). In instances where the applicable internal power usage rate is not exceeded, the process may loop back to step 304. Returning to step 306, in instances where the applicable internal power usage rate is exceeded, the process may proceed to step 308.

In step 308, current power utilization profile in the electronic device (i.e. actually utilized resources, active functions, services, applications, etc.) is analyzed to determine possible changes to meet or substantially meet applicable internal power supply usage rate (e.g., switching between different resources, modifying usage profile of resources, shutting/terminating operations or apps, etc.). For example, adjusting operations (e.g., shutting down, ending or terminating, deferring, suspending, or putting into a sleep mode) may be determined. In step 310, the determined adjustments may be applied.

FIG. 4 is a flow chart that illustrates an example process for configuring power usage throttling-related priorities in an electronic device, in accordance with an example embodiment. Referring to FIG. 4, there is shown a flow chart 400 comprising a plurality of example steps for assigning and/or adjusting priority levels to applications, services, and/or resources in an electronic device (e.g., the electronic device 200 of FIG. 2).

In step 402, functions, applications, and/or services available in the electronic device may be identified as well as available resources (software and/or hardware) which may be used in conjunction with running or execution of the available functions, applications, and/or services. In step 404, performance related data (including power consumption) associated with the available functions, applications, services, and the available SW/HW resources may be determined. In step 406, a default priority may be determined and applied to each of the available functions, applications, services, and/or resources. In this regard, in some instances multiple priority levels may be available, such that different functions, applications, services, and/or resources may be assigned different priority levels. The values of priority levels may represent, for example, preference (e.g., in ascending order) for keeping the functions, applications, services, and/or resources unchanged, or to allow adjusting the applications and/or their operations (e.g., shutting them down, terminating or ending them, suspending them, etc.). For example, in a 3-level priority technique, priority level ‘3’ may be assigned to functions, applications, services, and/or resources that are most favorite to be kept unchanged whereas priority level ‘1’ may be assigned to applications or services that are least favorite with respect to power consumption related adjustments.

In step 408, whether a user of the device requests particular configuration or adjustment of priority level for one or more of the available functions, applications, services, and/or resources may be determined. In this regard, user requests may allow for changing previously set (default or otherwise) priority levels. In instances where there is no user request for (re)configuring priority level(s), the process may terminate. Otherwise, the process may proceed to step 410. In step 410, the electronic device may be configured to receive and apply user-specified priority adjustment(s) to each of corresponding one(s) of the available functions, applications, services, and/or resources—e.g., those identified by the user as requiring (re)configuration of their respective priority levels. In this regard, the electronic device may be configured to provide users with sufficient information to allow for such (re)configuration. For example, the electronic device may display available priority levels, details on each priority level (e.g., order, corresponding power supply level triggering action, etc.), listing of currently available functions, applications, services, and/or resources, and/or current applicable priority levels to each the available functions, applications, services, and/or resources.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for standby battery usage throttling for mobile devices.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method, comprising:
obtaining a target power supply depletion rate for a power supply of a device having a plurality of applications and a plurality of power-consuming components;
initiating performance of one or more operations requested by one or more applications of the plurality of applications using one or more power-consuming components of the plurality of power-consuming components;
determining that a power supply usage rate of the device exceeds the target power supply depletion rate;
determining one or more adjustments to one or both of: the one or more operations, and usage of the one or more power-consuming components; and
applying the one or more adjustments so as to cause the power supply usage rate to substantially meet the target power supply depletion rate.

2. The method of claim 1, wherein the target power supply depletion rate is based on a user-setting.

3. The method of claim 1, wherein obtaining the target power supply depletion rate comprises:
determining the target power supply depletion rate based on an expected run time for the device using the power supply.

4. The method of claim 1, further comprising:
determining respective priority levels for the one or more applications, wherein determining the one or more adjustments comprises determining the one or more adjustments based on the respective priority levels.

5. The method of claim 4, wherein determining the respective priority levels comprises:
assigning the respective priority levels for the one or more application based on a user-specified ranking of the one or more applications.

6. The method of claim 1, wherein applying the one or more adjustments comprises shutting down or terminating an application of the one or more applications.

7. The method of claim 1, wherein applying the one or more adjustments comprises one or more of terminating use of a power-consuming component of the one or more power-consuming components, shutting down the power-consuming component, and switching from the power-consuming component to another power-consuming component.

8. The method of claim 1, further comprising:
maintaining respective profiles for the plurality of power-consuming components of the device, wherein a given profile comprises information defining power consumption by a corresponding power-consuming component when used by a given application, and wherein determining the one or more adjustments comprises:
determining the one or more adjustments to the usage of the one or more power-consuming components based on the respective profiles.

9. A device, comprising:
a plurality of applications;
a power supply;
a plurality of power-consuming components;
at least one processor in communication with the plurality of applications, the power supply, and the plurality of power-consuming components; and
data storage comprising instructions that, when executed by the at least one processor, cause the device to perform functions comprising:
obtaining a target power supply depletion rate for the power supply;
initiating performance of one or more operations requested by one or more applications of the plurality of applications using one or more power-consuming components of the plurality of power-consuming components;
determining that a power supply usage rate of the device exceeds the target power supply depletion rate;
determining one or more adjustments to one or both of: the one or more operations, and usage of the one or more power-consuming components; and
applying the one or more adjustments so as to cause the power supply usage rate to substantially meet the target power supply depletion rate.

10. The device of claim 9, wherein the target power supply depletion rate is based on a user-setting.

11. The device of claim 9, wherein the function of obtaining the target power supply depletion rate comprises:
determining the target power supply depletion rate based on an expected run time for the device using the power supply.

12. The device of claim 9, wherein the functions further comprise:
determining respective priority levels for the one or more applications, wherein determining the one or more adjustments comprises determining the one or more adjustments based on the respective priority levels.

13. The device of claim 12, wherein the function of determining the respective priority levels comprises:
assigning the respective priority levels for the one or more application based on a user-specified ranking of the one or more applications.

14. The device of claim 9, wherein the function of applying the one or more adjustments comprises:
terminating at least one application of the one or more applications.

15. The device of claim 9, wherein the function of applying the one or more adjustments comprises one or more of:
terminating use of at least one power-consuming component of the one or more power-consuming components, deactivating the power-consuming component, and switching from the power-consuming component to another power-consuming component.

16. The device of claim 9, wherein the functions further comprise:
maintaining respective profiles for the plurality of power-consuming components of the device, wherein a given profile comprises information defining power consumption by a corresponding power-consuming component when used by a given application, and wherein determining the one or more adjustments comprises:
determining the one or more adjustments to the usage of the one or more power-consuming components based on the respective profiles.

17. A computer readable memory having stored thereon instructions that, when executed by a computing device, cause the computing device to perform functions comprising:
determining a power supply usage rate of the computing device based on one or more operations of a plurality of applications and a plurality of power-consuming components of the computing device;
obtaining a target power supply depletion rate; and
based on the power supply usage rate exceeding the target power supply depletion rate, adjusting one or both of: an operation of an application of the plurality of applications, and an operation of a power-consuming component of the power-consuming components so as to cause the power supply usage rate to substantially meet the target power supply depletion rate.

18. The computer readable medium of claim 17, wherein the function of adjusting the operation of the application comprises:
terminating the application or deferring performance of the operation.

19. The computer readable medium of claim 17, wherein the function of adjusting the operation of the power-consuming component comprises:
terminating use of the power-consuming component, disabling the power-consuming component, or switching from using the power-consuming component to another power-consuming component.

20. The computer readable medium of claim 17, wherein the functions further comprise:
maintaining respective profiles for the plurality of power-consuming components of the computing device, wherein a given profile comprises information defining power consumption by a corresponding power-consuming component when used by a given application, and wherein the function of adjusting the operation of the power-consuming component comprises adjusting the operation based on the respective profiles.
